(19) United States
(12) Patent Application Publication
(10) Pub. No.: US 2002/0082812 A1
(43) Pub. Date: Jun. 27, 2002

(54) Apparatus and method for simulating the receiving characteristic of radio waves

(75) Inventors: Shinya Yamaguchi, Kawasaki (JP); Kenji Nagase, Kawasaki (JP); Shinichi Ohtsu, Kawasaki (JP); Makoto Mukai, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/865,732

(22) Filed: May 29, 2001

(30) Foreign Application Priority Data
Dec. 26, 2000 (JP) 2000-393989

(51) Int. Cl. G06F 17/10

(52) U.S. Cl. 703/2

(57) ABSTRACT

In Moment method, by regarding the current values of a wave source to be constants, the simultaneous equations of the wave source and the simultaneous equations of a receiving object can be separated and the current values of the wave source and the current values of the object can be separately calculated. Even if the positional relationship between the wave source and object changes, the mutual impedance between the elements of the object does not change. Therefore, there is no need to calculate the coefficient matrix of the simultaneous equations of the object again.

### BACKGROUND OF THE INVENTION

1. Field of the Invention

The present invention relates to an apparatus for simulating the receiving characteristic of an object that receives radio waves in the analysis of radio waves transmitted from a radio wave generation source and a method thereof.

2. Description of the Related Art

Receiving sensitivity based on the directivity characteristic of an antenna is the major factor of a product that receives radio waves from outside, such as a cellular phone, a car antenna, etc. These products are assumed to be called “equipment under test (EUT) ”. Software programs for virtually modeling and calculating the directivity characteristic against radio waves from outside of an EUT are conventionally used.

FIG. 1A shows the relationship between a transmitting antenna, which is a radio wave generation source (wave source) and a receiving antenna included in an EUT, in such a model. In FIG. 1A, the directivity characteristic of a receiving antenna 12 can be checked by rotating a transmitting antenna 11 by arbitrary angle θ using the receiving antenna 12 as the center and calculating voltage Vᵢₙ at the arbitrary point of the receiving antenna 12 when electric field is applied to the receiving antenna 12 from the transmitting antenna 11. This Vᵢₙ is called the “receiving sensitivity” of the receiving antenna 12. In this case, the value of Vᵢₙ varies depending on rotation angle θ, and the directivity characteristic shown in FIG. 1B is detected.

In FIG. 1B, a coordinate axis 13 indicates the direction in which the receiving sensitivity of the receiving antenna 12 is maximum, and length from origin O up to point P, which is on a curved line 15, on a straight line 14 obtained by rotating this coordinate axis by arbitrary angle θ indicates Vᵢₙ against θ. In other words, the curved line 15 indicates the value of voltage Vᵢₙ against each value of angle θ.

As one method for calculating the directivity characteristic of the receiving antenna 12 by replacing the antenna 12 with an EUT in an arbitrary shape, Moment method is known. Moment method is one solution key to an integral equation led from Maxwell's electromagnetic wave equation, as disclosed, for example, in an “Electromagnetic Field Intensity Calculation Apparatus” (Japan Patent Laid-open Application No. 7-234890), and it is a method for dividing an object into many small elements and calculating current that flows through each element. If the current that flows through each element is obtained, the voltage at an arbitrary point of the object can be calculated.

To calculate the directivity characteristic of an EUT by Moment method, a system consisting of a transmitting antenna and an EUT must be modeled, the system must be divided into small elements and current that flows through each element of the EUT must be calculated. The simultaneous equations of Moment method can be given as follows.

[Zᵢⱼ][Iⱼ]=[Vᵢ] (1)

In the above equation, [Zᵢⱼ] is a matrix having mutual impedance Zᵢⱼ between the i-th and j-th elements of the system as an element, [Iⱼ] is column vector having current Iⱼ that flows through the j-th element as an element and [Vᵢ] is column vector having the voltage Vᵢ of the i-th element as an element. Of these, [Vᵢ] is given as the wave-source voltage of the model and [Zᵢⱼ] is calculated based on the model. [Iⱼ] corresponds to the unknown of the simultaneous equations.

FIG. 1C is a flowchart showing a conventional current calculation process by such Moment method. A conventional processing apparatus first reads the data of the model consisting of the transmitting antenna and EUT (step S1) and calculates mutual impedance Zᵢⱼ against the initial value of the rotation angle of the transmitting antenna (step S2).

Then, the apparatus generates the coefficient matrix [Zᵢⱼ] of equation (1), performs the LDU factorization of the matrix (step S3) and calculates current Iⱼ by forward substitution/backward substitution (step S4). LDU factorization means an operation to convert a coefficient matrix into the product of lower triangular matrix L, diagonal matrix D and upper triangular matrix U, and forward/backward substitution means a calculation method for calculating a solution using these matrices.

Then, the processing apparatus judges whether the angle of the transmitting antenna should be changed (step S5). If the angle should be changed, the apparatus calculates mutual impedance Zᵢⱼ against a subsequent angle (step S2) and performs the processes in and after step S3. If the current calculation at all angles is completed, in step S5 the apparatus stops the change of the angle and terminates the process.

However, the conventional calculation method described above has the following problems.

According to the conventional calculation method, mutual impedance Zᵢⱼ in the left side of equation (1) must be calculated, mutual impedance matrix [Zᵢⱼ] must be reorganized and the simultaneous equations must be solved every time the antenna angle is changed. In this case, it takes a long time to calculate even the value of one piece of mutual impedance Zᵢⱼ. Therefore, if the number of system elements increases, it takes an enormous time to calculate all elements of the mutual impedance Zᵢⱼ composing mutual impedance matrix[Zᵢⱼ]. Furthermore, if mutual impedance matrix [Zᵢⱼ] is reorganized for k angles, the calculation time becomes k times as long as that.

### SUMMARY OF THE INVENTION

It is an object of the present invention to provide a simulation apparatus for improving the simulation speed of the receiving characteristic of an object in an arbitrary shape that receives radio waves and a method thereof.

The simulation apparatus of the present invention comprises first and second current calculation devices, a current storage device and an output device. The apparatus simulates the receiving characteristic of an object that receives radio waves transmitted from a wave source.

The first current calculation device calculates the current values of the wave source using the simultaneous equations of the wave source, which have currents that flow through respective elements as unknowns when the wave source is divided into a plurality of elements. The current storage device stores the current values of the wave source. The second current calculation device calculates the current values of the object using the simultaneous equations of the object, which have currents that flow through respective elements and the current values stored in the current storage device as unknowns and constants, respectively, when the object is divided into a plurality of elements and the positional relationship between the wave source and object changes. The output device calculates the receiving characteristic of the object based on the current values of the object, and outputs the receiving characteristic.

### BRIEF DESCRIPTIONS OF THE DRAWINGS

FIG. 1A shows transmitting and receiving antennas.

FIG. 1B shows the directivity characteristic of the receiving antenna.

FIG. 1C is a flowchart showing a conventional current calculation process.

FIG. 2A shows the basic configuration of the simulation apparatus of the present invention.

FIG. 2B shows an analysis model.

FIG. 3 shows the simultaneous equations of the model.

FIG. 4 shows the simultaneous equations of the current of the transmitting antenna.

FIG. 5 shows the simultaneous equations of the current of an EUT.

FIG. 6 shows the configuration of the simulation apparatus.

FIG. 7 is a flowchart showing the first simulation process.

FIG. 8 is a flowchart showing the second simulation process.

FIG. 9 shows the configuration of an information processing device.

FIG. 10 shows storage media.

### DESCRIPTIONS OF THE PREFERRED EMBODIMENTS

The detailed preferred embodiments are described below with reference to the drawings.

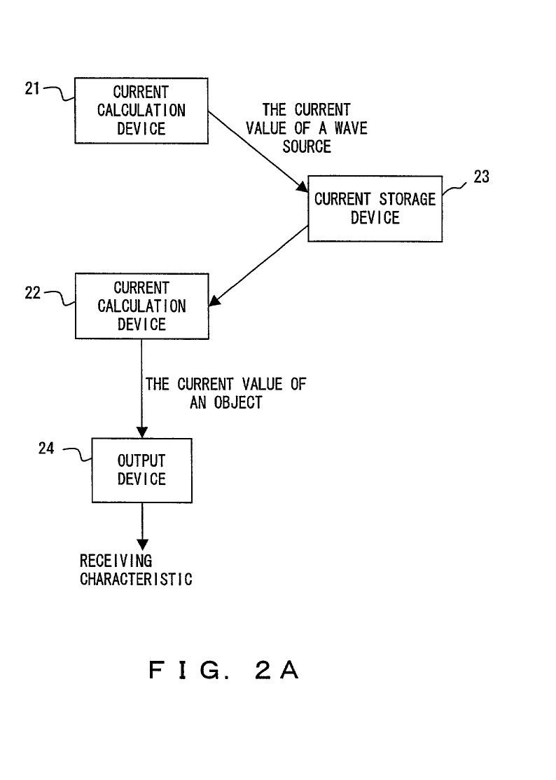

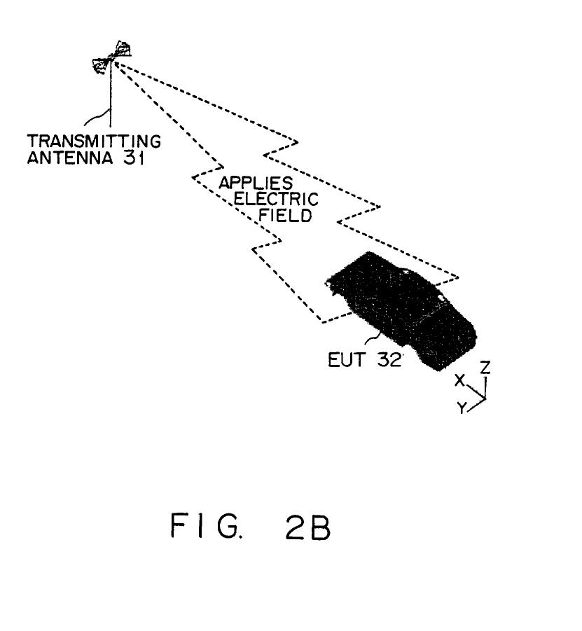

FIG. 2A shows the basic configuration of the simulation apparatus of the present invention. The simulation apparatus shown in FIG. 2A comprises current calculation devices 21 and 22, a current storage device 23 and an output device 24. The apparatus simulates the receiving characteristic of an object that receives radio waves transmitted from a wave source.

The current calculation device 21 calculates the current values of the wave source using the simultaneous equations of the wave source, which have currents that flow through respective elements as unknowns when the wave source is divided into a plurality of elements. The current storage device 23 stores the current values of the wave source. The current calculation device 22 calculates the current values of the object using the simultaneous equations of the object, which have currents that flow through respective elements and the current values stored in the current storage device 23 as unknowns and constants, respectively, when the object is divided into a plurality of elements and the positional relationship between the wave source and object changes. The output device 24 calculates the receiving characteristic of the object based on the current values of the object, and outputs the receiving characteristic.

The wave source, for example, corresponds to a transmitting antenna, and the object, for example, corresponds to the receiving antenna or EUT. The simulation apparatus generates simultaneous equations concerning the wave source and simultaneous equations concerning the object separately, and calculates current values.

First, the current calculation device 21 calculates the current value of the wave source by solving the simultaneous equations concerning the currents of a plurality of elements composing the wave source, and stores the values in the current storage device 23. Then, when the relative-position relationship between the wave source and object changes, the current calculation device 22 extracts the current values stored in the current storage device 23, and generates simultaneous equations concerning the currents of the plurality of elements composing the object using those values as constants. Then, the unit 22 calculates the current values of the object by solving the simultaneous equations and outputs the values to the output device 24. The output device 24 calculates the receiving characteristic of the object, such as receiving sensitivity, etc., using the received current values and outputs the characteristic.

According to such a simulation apparatus, the simultaneous equations of a wave source and simultaneous equations of an object can be separated by regarding the current values of the wave source to be constant, and the current values of the wave source and the current values of the object can be separately calculated. In this case, the coefficient matrix of the simultaneous equations of the wave source can be composed of only mutual impedance between the elements of the wave source, and the coefficient matrix of the simultaneous equations of the object can be composed of only mutual impedance between the elements of the object.

Since these pieces of mutual impedance do not change even if the relative position of the wave source against the object changes, one time of the calculation of the coefficient matrix is sufficient. In this way, there is no need to repeat the calculation of the coefficient matrix for each angle of the transmitting antenna as in the conventional method, and as a result, process time can be greatly reduced.

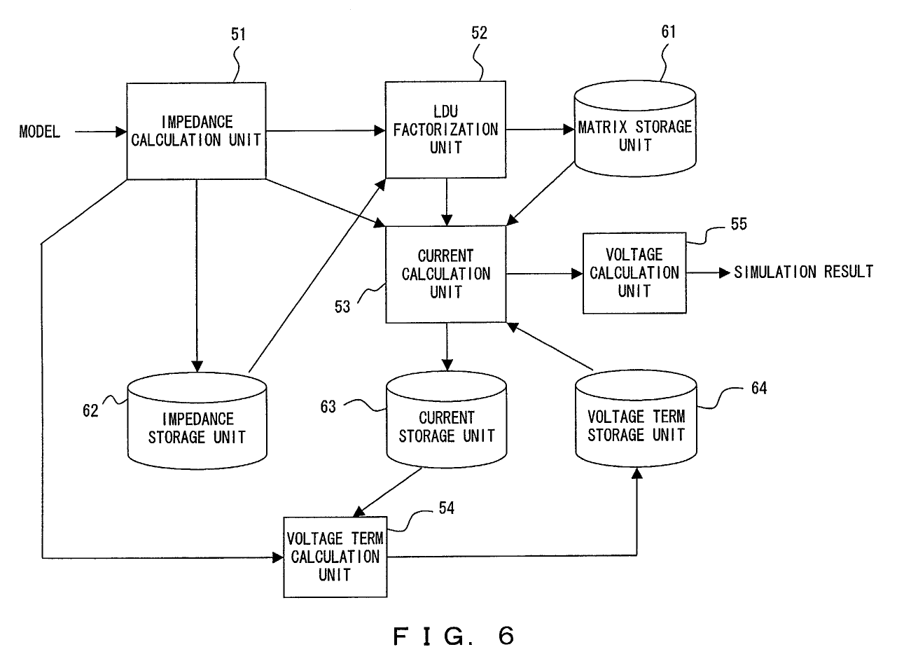

For example, the current calculation devices 21 and 22 shown in FIG. 2A correspond to the current calculation unit 53 shown in FIG. 6, which is described later, the current storage device 23 shown in FIG. 2A corresponds to the current storage unit 63 shown in FIG. 6, and the output device 24 shown in FIG. 2A corresponds to the voltage calculation unit 55 shown in FIG. 6.

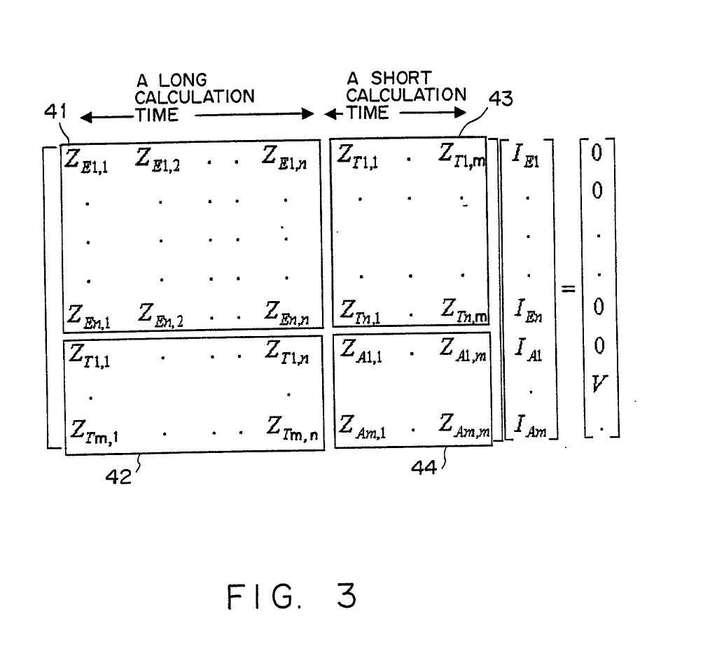

FIG. 2B shows the analysis model of a system consisting of a transmitting antenna and an EUT. In the model of FIG. 2B, a transmitting antenna 31 corresponds to the wave source of radio waves, and it transmits radio waves by applying electric field to the EUT 32. The EUT 32 corresponds to a car equipped with a glass antenna, and it receives radio waves transmitted from the transmitting antenna 31. In this case, equation (1) can be replaced with the simultaneous equations shown in FIG. 3.

In the coefficient matrix shown in FIG. 3, a submatrix 41 has mutual impedance ZE_{i,j} (i=1, . . . , n, j=1, . . . , n) among n elements composing the EUT 32 as an element, and submatrix 44 has mutual impedance ZA_{i,j (i=}1, . . . , m, j=1, . . . , m) among m elements composing the transmitting antenna 31 as an element.

A submatrix 42 has mutual impedance ZT_{i,j} (i=1, . . . , n, j=1, . . . , m) between an element composing the EUT 32 and an element composing the transmitting antenna 31, as an element, and submatrix 43 has mutual impedance ZT_{i,j}(i=1, . . . , m, j=1, . . . , n) as an element.

Current IEⱼ (j=1, . . . , n) indicates a current that flows through each element of the EUT 32, and current IAⱼ (j=1, . . . , m) indicates a current that flows through each element of the transmitting antenna 31. Voltage V is the transmitting voltage of the transmitting antenna 31.

If there is a sufficient distance between the transmitting antenna 31 and EUT 32, it is considered that the influence on the transmitting antenna 31 of current that flows through the EUT 32 is very small. Therefore, even if the angle of the transmitting antenna 31 against the EUT 32 changes, current that flows through the transmitting antenna 31 hardly changes and can be regarded to be constant. In this case, the transmitting antenna 31 can be used as a constant current source in the calculation of the current of the EUT 32.

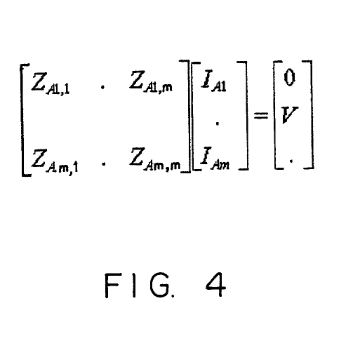

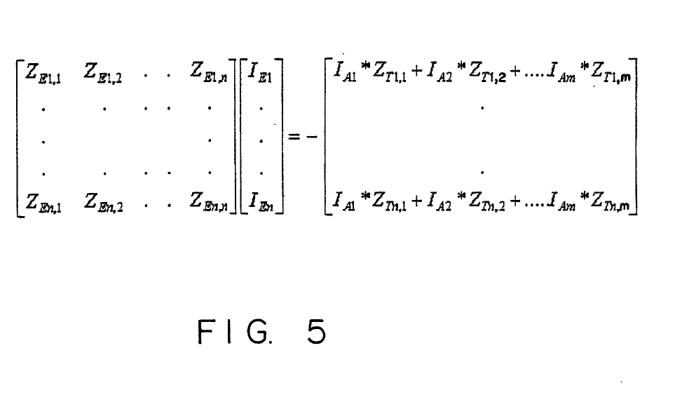

Therefore, first, only the transmitting antenna 31 is modeled, and the currents IAₗ, through IAₘ of the transmitting antenna 31 are calculated. Simultaneous equations having only the currents IAₗ, through IAₘ as unknowns can be generated as shown in FIG. 4 using the submatrix 44 shown in FIG. 3. Current values obtained by solving these simultaneous equations are input as known values to simultaneous equations having the small matrices 41 and 43 as coefficient matrices, and simultaneous equations in which only currents IE₁ through IEₙ of the EUT 32 are unknown, are generated. Simultaneous equations concerning currents IE₁ through IEₙ, are generated as shown in FIG. 5.

In FIG. 5, voltage terms on the right side are given by the product of current IAⱼ and mutual impedance ZT_{I,j} and they vary depending on the angle of the transmitting antenna 31. However, since mutual impedance matrix [ZE_{i,j}] on the left side does not vary depending on the angle, one time of this matrix calculation is sufficient.

For example, if it is assumed that n is approximately 30,000-40,000 and m is approximately 100, the calculation of mutual impedance ZE_{i,j} requires far longer time than the calculation of mutual impedance ZTᵢⱼ. Therefore, by omitting the calculation of mutual impedance ZE_{i,j} when the angle is changed, the speed of current calculation can be greatly improved. Such a simplified calculation method can be generally used when there is a sufficient distance between a transmitting unit, which is a wave source, and a receiving unit that receives radio waves.

FIG. 6 shows the configuration of the simulation apparatus based on such a current calculation method.

The simulation apparatus shown in FIG. 6 comprises an impedance calculation unit 51, an LDU factorization unit 52, a current calculation unit 53, a voltage term calculation unit 54, a voltage calculation unit 55, a matrix storage unit 61, an impedance storage unit 62, a current storage unit 63 and a voltage term storage unit 64.

The impedance calculation unit 51 calculates the mutual impedance of a given model and stores the impedance in the impedance storage unit 62. The LDU factorization unit 52 generates a mutual impedance matrix having the calculated mutual impedance as an element, performs the LDU factorization of the matrix and stores the factorized matrix data in the matrix storage unit 61.

The current calculation unit 53 calculates currents using necessary data out of data from the impedance calculation unit 51, data from the LDU factorization unit 52, data from the matrix storage unit 61 and data from the voltage term storage unit 64, and stores the currents in the current storage unit 63.

The voltage term calculation unit 54 calculates the voltage terms shown in FIG. 5 using both the data from the impedance calculation unit 51 and data from the current storage unit 63, and store the voltage terms in the voltage term storage unit 64.

The voltage calculation unit 55 calculates voltage in the prescribed position of the EUT using the data from the current calculation unit 53, and outputs the value as a simulation result.

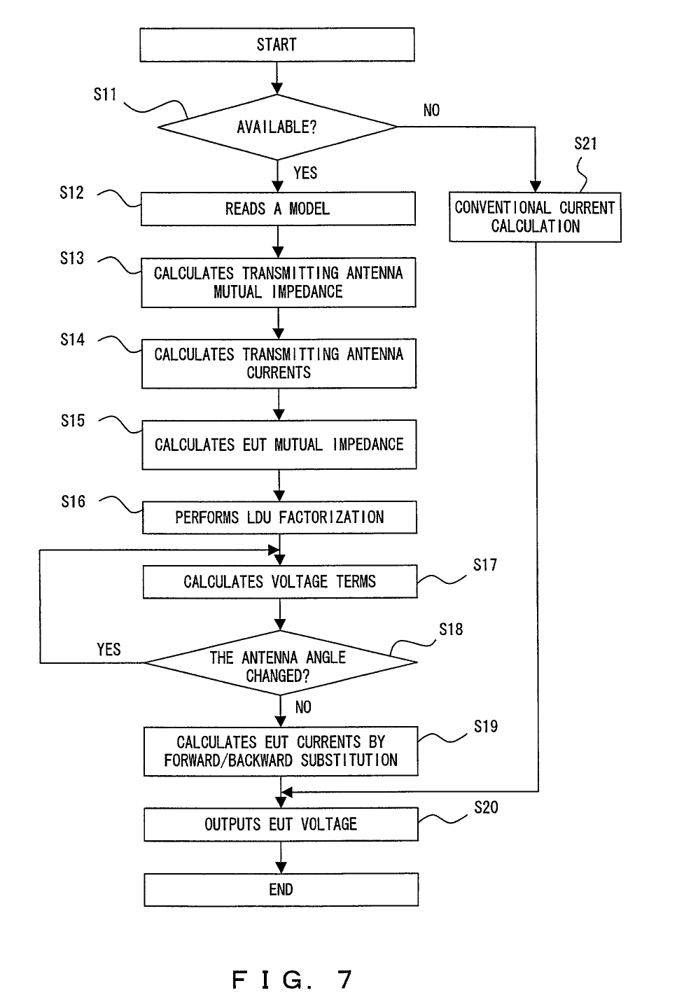

FIG. 7 is a flowchart showing the simulation process of the simulation apparatus shown in FIG. 6.

The simulation apparatus first judges whether a calculation method that regards the current of the transmitting antenna to be constant is applicable to the given model (step S11). For example, the apparatus checks whether a distance between the transmitting antenna and EUT is equal to or longer than a prescribed threshold value. If the distance is equal to or longer than the threshold value, the apparatus judges that this calculation method is applicable. If the distance is shorter than the threshold value, the unit judges that this calculation method is not applicable.

If this calculation method is applicable, the simulation apparatus reads the data of the model consisting of the transmitting antenna and EUT (step S12) . The impedance calculation unit 51 calculates the mutual impedance ZA_{i,j} of the transmitting antenna only and outputs the calculation result to the current calculation unit 53 (step S13). Then, the current calculation unit 53 generates the simultaneous equations shown in FIG. 4 using the received mutual impedance ZA_{i,j}, calculates the current IAⱼ of the transmitting antenna and stores the current in the current storage unit 63 (step S14).

Then, the impedance calculation unit 51 calculates the mutual impedance ZE_{i,j} of the EUT only, and outputs the calculation result to the LDU factorization unit 52 (step S15). Then, the LDU factorization unit 52 generates mutual impedance matrix [ZE_{i,j} ] using the received mutual impedance ZE_{i,j}, performs the LDU factorization of the matrix and stores the factorization result in the matrix storage unit 61 (step S16).

Then, the impedance calculation unit 51 calculates the mutual impedance ZT_{i,j} between the transmitting antenna and EUT, and outputs the calculation result to the voltage term calculation unit 54. Then, the voltage term calculation unit 54 calculates the voltage terms shown in FIG. 5 using both the received mutual impedance ZT_{i,j} and the current IAⱼ stored in the current storage unit 63, and stores the voltage terms in the voltage term storage unit 64 (step S17).

Then, the simulation apparatus judges whether the angle of the transmitting antenna should be changed (step S18). If the angle should be changed, the impedance calculation unit 51 calculates new mutual impedance ZT_{i,j} against a subsequent angle. The voltage term calculation unit 54 calculates new voltage terms using both the new mutual impedance ZT_{i,j} and the current IAⱼ stored in the current storage unit 63, and stores the voltage terms in the voltage term storage unit 64 (step S17). Then, when the calculation of voltage terms at all angles is completed, in step S18, the simulation apparatus stops the change of the angle.

Then, the current calculation unit 53 generates the simultaneous equations shown in FIG. 5 using both the factorization result of the mutual impedance matrix [ZT_{i,j}] stored in the matrix storage unit 61 and the voltage terms stored in the voltage term storage unit 64. Then, the unit 53 calculates EUT current IEⱼ against each angle by forward/backward substitution and outputs the current to the voltage calculation unit 55 (step S19).

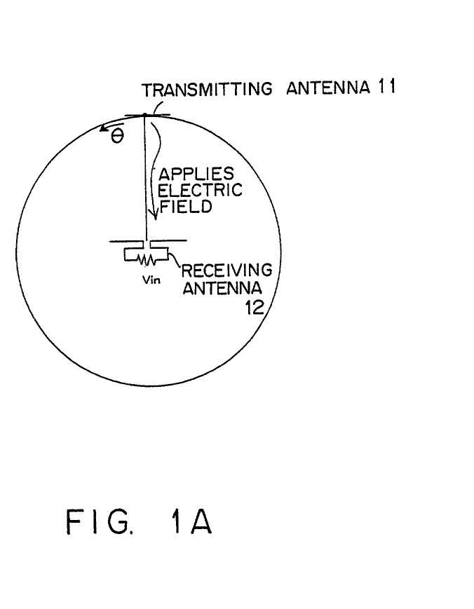

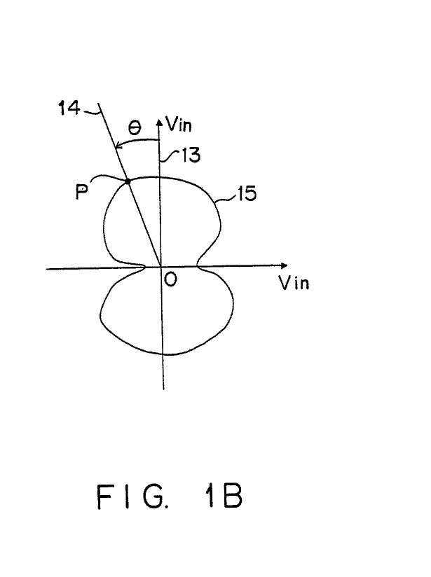

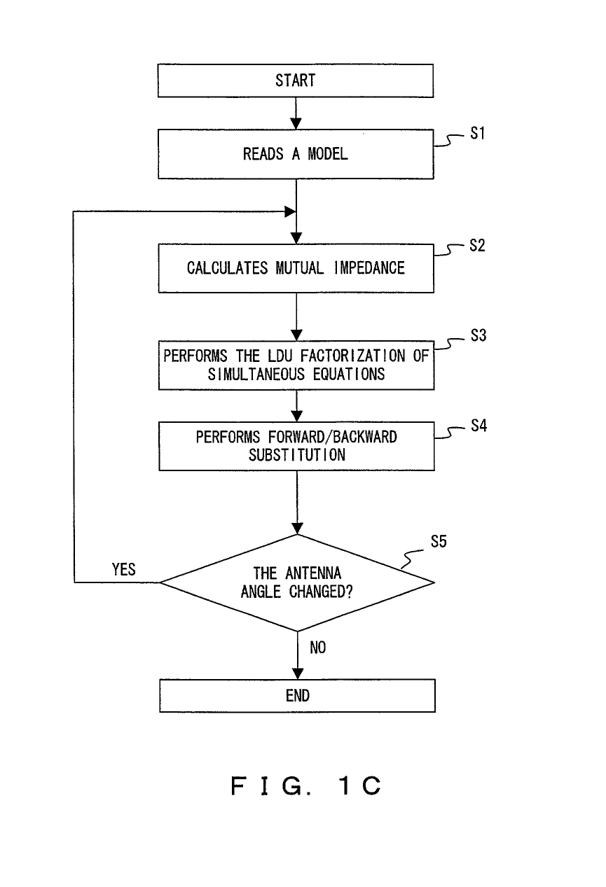

Then, the voltage calculation unit 55 calculates EUT voltage against each angle using the received current IEⱼ, and outputs the calculation result as the receiving characteristic of the EUT (step S20). In this case, the calculation result of the voltage values is displayed on the screen, for example, in the form of a directivity characteristic graph, as shown in FIG. 1B.

If in step S11 the calculation method in which the current of the transmitting antenna is constant is not available, the simulation apparatus calculates currents according to the process shown in FIG. 1C (step S21) and performs the process in step S20.

According to such a simulation process, one time of the calculation of EUT mutual impedance ZE_{i,j}, which takes the longest time, is sufficient. Therefore, process time can be greatly reduced. Since one time of the LDU factorization of a mutual impedance matrix [ZE_{i,j}] is also sufficient, process speed can be further improved.

The effects of this simulation process are described below using as an example an analysis in which the directivity characteristic of a glass antenna of a car is calculated by irradiating radio waves to the car from a transmitting antenna. If there are 72 transmitting antenna angles to be simulated, according to the conventional calculation method, first the total analysis time is calculated as follows.

Analysis time=(Analysis time per angle)×72 (2)

According to the calculation method shown in FIG. 7, the total analysis time is calculated as follow.

Analysis time=(Analysis time per angle)×1+(Calculation time of mutual impedance between antenna and EUT)×71 (3)

In these equations, (Calculation time of mutual impedance between antenna and EUT)<<(Analysis time per angle). Therefore, the analysis time of equation (3) can be regarded to be almost equal to analysis time per angle. In other words, process speed can be improved approximately 72 times as fast as that by adopting the calculation method shown in FIG. 7.

Although in the simulation process shown in FIG. 7, EUT directivity characteristic against the change in rotation angle of a transmitting antenna is simulated, similarly, an EUT receiving characteristic against the change in relative position of a transmitting antenna against an EUT can also be simulated.

In this case, the simulation apparatus calculates mutual impedance ZT_{i,j} corresponding to a new position by changing the position of the transmitting antenna. Then, the apparatus generates EUT simultaneous equations against the new position using the mutual impedance ZT_{i,j}, current IAⱼ stored in the current storage unit 63 and matrix data stored in the matrix storage unit 61, and calculates new current values.

As described above, the simulation process is effective if there is a sufficient distance between a transmitting antenna and an EUT. However, process speed can also be improved without such a condition. For example, the mutual impedance calculation time shown in FIG. 3 can be reduced by storing EUT mutual impedance ZE_{i,j} and using the impedance in the current calculation at each angle.

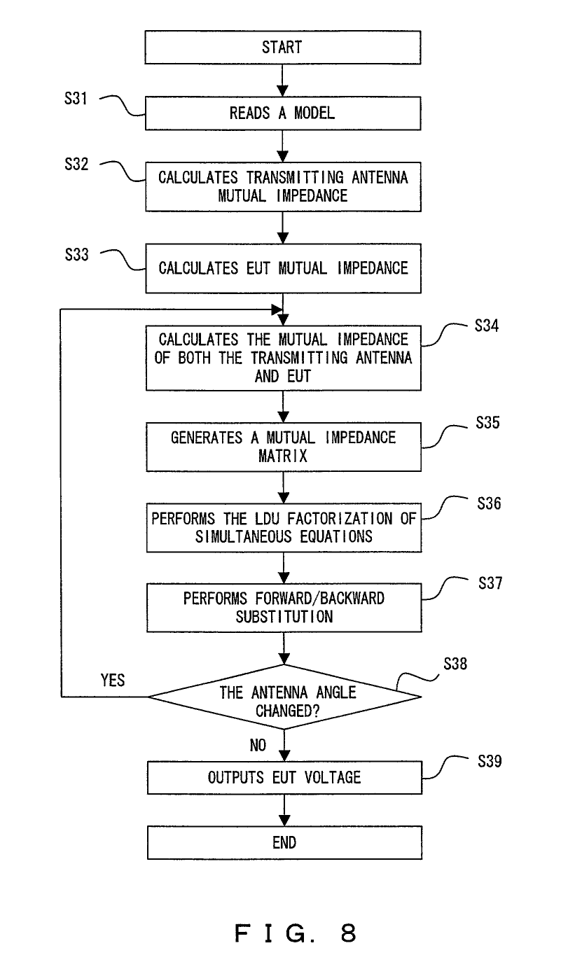

FIG. 8 is a flowchart showing such a simulation process.

The simulation apparatus first reads the data of a model consisting of a transmitting antenna and an EUT (step S31). The impedance calculation unit 51 calculates the mutual impedance ZA_{i,j} of the transmitting antenna and stores the impedance in the impedance storage unit 62 (step S32).

Then, the impedance calculation unit 51 calculates the mutual impedance ZE_{i,j} of the EUT, stores the impedance in the impedance storage unit 62 (step S33), calculates the mutual impedance ZT_{i,j} between the transmitting antenna and EUT and outputs the calculation result to the LDU factorization unit 52.

In this case, the mutual impedance ZA_{i,j} and ZE_{i,j} are stored in the impedance storage unit 62 as data independent from the angle of the transmitting antenna, and ZT_{i,j} is outputted to the LDU factorization unit 52 as data dependant on the angle of the transmitting antenna.

Then, the LDU factorization unit 52 extracts the mutual impedance ZA_{I,j} and ZE_{i,j} stored in the impedance storage unit 62, and generates the mutual impedance matrix shown in FIG. 3 using those pieces of data and the mutual impedance ZT_{i,j} received from the impedance calculation unit 51 (step S35). Then, the unit 52 performs the LDU factorization of the matrix and outputs the factorization result to the current calculation unit 53 (step S36).

Then, the current calculation unit 53 generates the simultaneous equations shown in FIG. 3 using the received analysis result of the mutual impedance matrix. Then, the unit 53 calculates both the current IEⱼ of the EUT and the current IAⱼ, of the transmitting antenna by forward/backward substitution, and outputs the current IEⱼ to the voltage calculation unit 55 (step S37).

Then, the simulation apparatus judges whether the angle of the transmitting antenna should be changed (step S38). If the angle should be changed, the impedance calculation unit 51 calculates new mutual impedance ZT_{i,j} against a subsequent angle and outputs the calculation result to the LDU factorization unit 52 (step S34). Then, the LDU factorization unit 52 generates a mutual impedance matrix using the received mutual impedance ZT_{i,j}, and ZA_{i,j} and ZE_{i,j} stored in the impedance storage unit 62. Then, processes in steps S36 and S37 are repeated based on the newly generated mutual impedance matrix.

If in this way, current calculation at all angles are completed, in step S38 the simulation apparatus stops the change of the angle. Then, the voltage calculation unit 55 calculates EUT voltage against each angle using the received current IEⱼ and outputs the voltages as a receiving characteristic (step S39).

According to such a simulation process, as in the process shown in FIG. 7, one time of the calculation of EUT mutual impedance ZE_{i,j} is sufficient. Therefore, process time can be greatly reduced.

Although in the example of FIG. 2B, a car is used as EUT, in this preferred embodiment, an analysis model can also be generated using an arbitrary object instead of the car. Although in this preferred embodiment, LDU factorization is used as the solution key to simultaneous equations, an arbitrary matrix factorization method can also be used instead of the LDU factorization. For example, LU factorization for converting a coefficient matrix into the product of lower triangle matrix L and upper triangle matrix U can also be used.

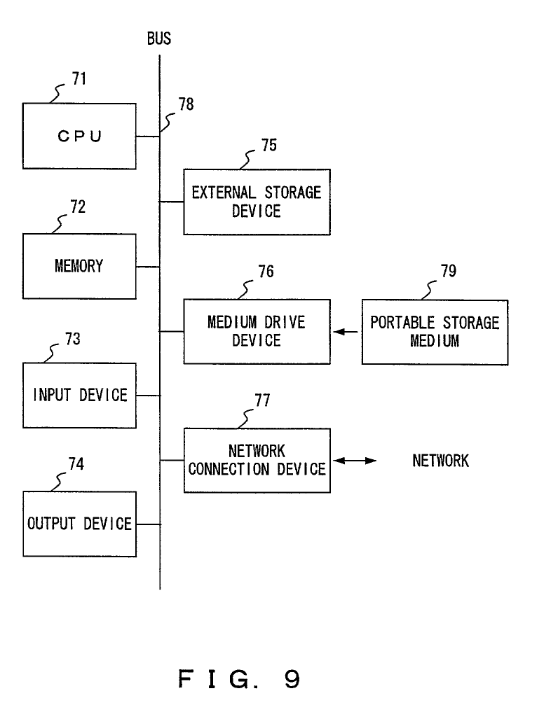

The simulation apparatus shown in FIG. 6 can be configured using, for example, the information processing device (computer) shown in FIG. 9. The information processing device shown in FIG. 9 comprises a CPU (central processing unit) 71, a memory 72, an input device 73, an output device 74, an external storage device 75, a medium drive device 76 and a network connection device 77, and those are connected to one another by a bus 78.

The memory 72 includes, for example, a ROM (read-only memory), a RAM (random-access memory), etc., and it stores both a program and data to be used for the process. The CPU 71 performs necessary processes by using the memory 72 and executing the program.

The impedance calculation unit 51, LDU factorization unit 52, current calculation unit 53, voltage term calculation unit 54 and voltage calculation unit 55 that are shown in FIG. 6 correspond to a software component described by a program and each unit is stored in the specific program code segment of the memory 72.

The input device 73 is, for example, a keyboard, a pointing device, a touch panel, etc., and is used for a user to input instructions and information. The output device 74 is, for example, a display, a printer, a speaker, etc., and is used to output inquiries and process results to a user.

The external storage device 75 is, for example, a magnetic disk device, an optical disk device, a magneto-optical disk device, a tape device, etc. The information processing device stores the program and data described above in this external storage device 75, and uses them by loading them into the memory 72, as requested. The external storage device 75 can also be used as the matrix storage unit 61, impedance storage unit 62, current storage unit 63 and voltage term storage unit 64.

The medium drive device 76 drives a portable storage medium 79 and accesses the recorded contents. For the portable storage medium 79, an arbitrary computer-readable storage medium, such as a memory card, a floppy disk, a CD-ROM (compact disk read-only memory), an optical disk, a magneto-optical disk, etc. are used. A user stores the program and data in this portable storage medium 79, and uses them by loading them into the memory 72, as requested.

The network connection device 77 is connected to an arbitrary network, such as a LAN (local area network), etc., and transmits/receives data accompanying communications. The information processing device receives the program and data from another device, such as a server, etc., via the network connection device 77, and uses them loading them into the memory 72, as requested.

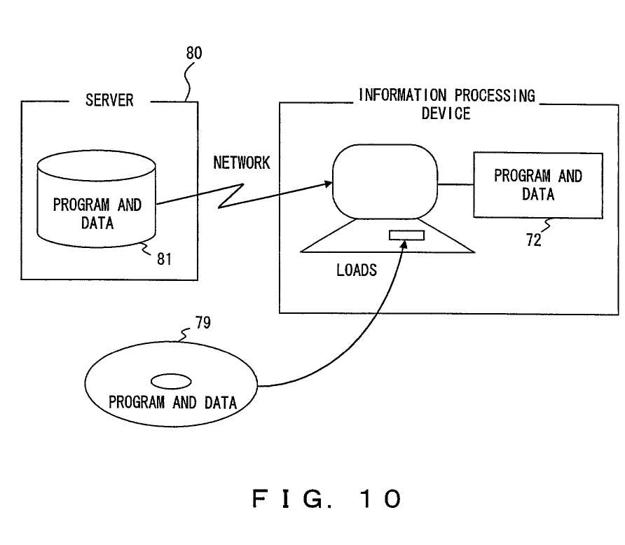

FIG. 10 shows computer-readable storage media for providing the information processing device shown in FIG. 9 with both a program and data. The program and data that are stored in the portable storage medium 79 or the database 81 of a server 80 are loaded into the memory 72. In this case, the server 80 generates a propagation signal for propagating the program and data, and transmits the propagation signal to the information processing device via an arbitrary transmission medium on a network. Then, the CPU 71 performs necessary processes by using the data and executing the program.

According to the present invention, in the simulation of the receiving characteristic of an object in the case where radio waves are transmitted from a wave source to an object in an arbitrary shape, the redundant calculation of mutual impedance can be omitted and as a result, the process speed of simulation can be improved.

What is claimed is:

1. A simulation apparatus for simulating a receiving characteristic of an object that receives a radio wave transmitted from a radio wave generation source, comprising:
a first current calculation device calculating current values of the generation source using simultaneous equations of the generation source when the generation source is divided into a plurality of elements, the simultaneous equations of the generation source having currents that flow through respective elements as unknowns;
a current storage device storing the current values of the generation source;
a second current calculation device calculating current values of the object using simultaneous equations of the object when the object is divided into a plurality of elements and a positional relationship between the generation source and object changes, the simultaneous equations of the object having currents that flow through respective elements as unknowns and the current values stored in the current storage device as constants; and
an output device calculating the receiving characteristic of the object based on the current values of the object and outputting the receiving characteristic of the object.

2. The simulation apparatus according to claim 1, wherein said second current calculation device includes a device calculating mutual impedance between elements of the object, a device calculating mutual impedance between an element of the generation source and an element of the object and a matrix storage device storing matrix data of mutual impedance between elements of the object, calculates mutual impedance between an element of the generation source and an element of the object corresponding to a new position when a position of the generation source changes, generates simultaneous equations of the object corresponding to the new position using the matrix data stored in the matrix storage device as a coefficient matrix and calculates new current values.

3. The simulation apparatus according to claim 2, wherein said second current calculation device further includes a factorization device factorizing the coefficient matrix by a prescribed factorization method and said matrix storage device stores matrix data of a factorized coefficient matrix.

4. The simulation apparatus according to claim 1, further comprising
a judging device judging whether a calculation method in which the current values of the generation source are regarded as constants can be used, wherein said second current calculation device calculates the current values of the object using the simultaneous equations of the object if the calculation method can be used.

5. A simulation apparatus for simulating a directivity characteristic of an object that receives a radio wave transmitted from a transmitting antenna, comprising:
a first current calculation device calculating current values of the transmitting antenna using simultaneous equations of the transmitting antenna when the transmitting antenna is divided into a plurality of elements, the simultaneous equations of the transmitting antenna having currents that flow through respective elements as unknowns;
a current storage device storing the current values of the transmitting antenna;
a matrix storage device storing matrix data of mutual impedance between elements of the object when the object is divided into a plurality of elements;
a device calculating mutual impedance between an element of the transmitting antenna and an element of the object for each angle of the transmitting antenna against the object;
a second current calculation device generating simultaneous equations of the object for each angle of the transmitting antenna using currents that flow through respective elements of the object as unknowns, matrix data stored in the matrix storage device as a coefficient matrix and both the current values stored in the current storage device and the mutual impedance between the element of the transmitting antenna and the element of the object as constants, and calculating current values of the object; and
an output device calculating the directivity characteristic of the object based on the current values of the object and outputting the directivity characteristic of the object.

6. A simulation apparatus for simulating a receiving characteristic of an object that receives a radio wave transmitted from a radio wave generation source, comprising:
an impedance storage device storing both data of mutual impedance between elements of the generation source when the generation source is divided into a plurality of elements and data of mutual impedance between elements of the object when the object is divided into a plurality of elements as data independent from a position of the generation source;
a device calculating mutual impedance between an element of the generation source and an element of the object corresponding to a new position when the position of the generation source changes;
a current calculation device calculating current values using simultaneous equations having currents that flow through respective elements of both the generation source and object as unknowns and having a matrix consisting of the data stored in the impedance storage device and the mutual impedance between the element of the generation source and the element of the object as a coefficient matrix; and
an output device calculating the receiving characteristic of the object based on the current values and outputting the receiving characteristic of the object.

7. A computer-readable storage medium on which is recorded a program for enabling a computer to simulate a receiving characteristic of an object that receives a radio wave transmitted from a radio wave generation source, said process comprising:
calculating current values of the generation source using simultaneous equations of the generation source when the generation source is divided into a plurality of elements, the simultaneous equations of the generation source having currents that flow through respective elements as unknowns;
storing the current values of the generation source;
calculating current values of the object using simultaneous equations of the object when the object is divided into a plurality of elements and a positional relationship between the generation source and object changes, the simultaneous equations of the object having currents that flow through respective elements as unknowns and the stored current values as constants;
calculating the receiving characteristic of the object based on the current values of the object; and
outputting the receiving characteristic of the object.

8. A propagation signal for propagating to a computer a program for enabling the computer to simulate a receiving characteristic of an object that receives a radio wave transmitted from a radio wave generation source, said process comprising:
calculating current values of the generation source using simultaneous equations of the generation source when the generation source is divided into a plurality of elements, the simultaneous equations of the generation source having currents that flow through respective elements as unknowns;
storing the current values of the generation source;
calculating current values of the object using simultaneous equations of the object when the object is divided into a plurality of elements and a positional relationship between the generation source and object changes, the simultaneous equations of the object having currents that flow through respective elements as unknowns and the stored current values as constants;
calculating the receiving characteristic of the object based on the current values of the object; and
outputting the receiving characteristic of the object.

9. A simulation method for simulating a receiving characteristic of an object that receives a radio wave transmitted from a radio wave generation source, comprising:
generating simultaneous equations of the generation source when the generation source is divided into a plurality of elements, the simultaneous equations of the generation source having currents that flow through respective elements as unknowns;
calculating current values of the generation source using the simultaneous equations of the object;
preserving the current values of the generation source;
generating simultaneous equations of the object according to a position of the object when the object is divided into a plurality of elements, the simultaneous equations of the object having currents that flow through respective elements as unknowns and the preserved current values as constants;
calculating current values of the object corresponding to the position of the object using the simultaneous equations of the object;
calculating the receiving characteristic of the object based on the current values of the object; and
presenting the receiving characteristic of the object.

10. A simulation apparatus for simulating a receiving characteristic of an object that receives a radio wave transmitted from a radio wave generation source, comprising:
first current calculation means for calculating current values of the generation source using simultaneous equations of the generation source when the generation source is divided into a plurality of elements, the simultaneous equations of the generation source having currents that flow through respective elements as unknowns;
current storage means for storing the current values of the generation source;
second current calculation means for calculating current values of the object using simultaneous equations of the object when the object is divided into a plurality of elements and a positional relationship between the generation source and object changes, the simultaneous equations of the object having currents that flow through respective elements as unknowns and the current values stored in the current storage means as constants; and
output means for calculating the receiving characteristic of the object based on the current values of the object and outputting the receiving characteristic of the object.
